(19) United States
(12) Patent Application Publication
(10) Pub. No.: US 2024/0181720 A1
(43) Pub. Date: Jun. 6, 2024

(54) Pressure Tool, Pressing Apparatus And Method For Welding Plastics Components

(71) Applicant: Premium Aerotec GmbH, Augsburg (DE)

(72) Inventors: Stefan Jarka, Augsburg (DE); Manuel Endrass, Augsburg (DE); Alexander Sänger, Augsburg (DE); Ralph Männich, Augsburg (DE)

(73) Assignee: Premium Aerotec GmbH, Augsburg (DE)

(21) Appl. No.: 18/285,073

(22) PCT Filed: Mar. 30, 2022
(86) PCT No.: PCT/EP2022/058489

§ 371 Date: Sep. 29, 2023

(30) Foreign Application Priority Data
Mar. 30, 2021 (DE) 10 2021 108 092.4

(51) Int. Cl. B29C 65/00

(52) U.S. Cl. CPC B29C 66/81457; B29C 66/91231; B29C 66/9241

(57) ABSTRACT

A pressure tool for applying a pressure force during the welding of plastics components has at least one metallic first component contact section, wherein the pressure tool has at least one elastically deformable second component contact section and is thermally controllable. A Pressure apparatus has at least one such pressure tool for pressing together plastics components during welding. A method for welding plastics components is carried out by such a pressure apparatus and plastics module having at least two welded-together plastics components, wherein the at least two plastics components are welded using such a method.

The invention relates to a pressure tool for applying a pressure force when welding plastic components, the pressure tool having at least one metallic first component contact section. The invention also relates to a pressure apparatus for pressing together plastic components during welding. Furthermore, the invention relates to a method for welding plastic components. Furthermore, the invention relates to a plastic module with at least two welded to one another plastic components.

Document DE 10 2009 047 671 A1 describes that composite laminates are susceptible to in-plane damage, such as delamination, and discloses an improved method for bonding a fiber composite member to a structural member comprising the steps of: Providing a metal foil as a transverse reinforcing member between the fiber composite member and the structural member; forming the metal foil with at least one anchoring portion projecting from the surface facing the fiber composite member; and inserting the metal foil between the fiber composite member and the structural member.

DE 10 2020 111 497 A1 relates to a method for pretreating a joining contact surface of a laminated fiber-plastic composite component in order to subsequently join the fiber-plastic composite component to another fiber-plastic composite component, the fiber-plastic composite component comprising a matrix material and reinforcing fibers embedded in the matrix material. The present patent application proposes to level the joining contact surface by applying a filler material compatible with the matrix material, so that the bond between the fiber-plastic composite components is improved.

The invention is based on the problem of structurally and/or functionally improving a pressure tool mentioned at the beginning. Furthermore, the invention is based on the task of structurally and/or functionally improving a pressure apparatus mentioned at the beginning. Furthermore, the invention is based on the task of improving a method mentioned at the beginning. Furthermore, the invention is based on the task of structurally and/or functionally improving a plastic module mentioned at the beginning.

The problem is solved with a pressure tool having the features of claim 1. Furthermore, the task is solved with a pressure apparatus having the features of claim 7. Furthermore, the task is solved with a method having the features of claim 9. Furthermore, the task is solved with a plastic module having the features of claim 15. Advantageous embodiments and/or further developments are the subject of the dependent claims.

The pressure tool can be used by means of a robot. The pressure tool can be designed as an effector for a robot. The pressure tool can have a connection section. The connection section may have at least one mechanical connection, at least one electrical power connection, and/or at least one electrical signal connection. The pressure tool may have a plate-like, cuboid-like, and/or strip-like shape. The pressure tool may have a length extending along a longitudinal axis, a width extending along a transverse axis, and a height extending along a vertical axis. The longitudinal axis may also be referred to as the x-axis, the transverse axis may also be referred to as the y-axis, and the vertical axis may also be referred to as the z-axis. The longitudinal axis, the transverse axis, and the vertical axis may be arranged at right angles to each other. The pressure tool may be for applying a pressure force in the direction of extension of the z-axis. The pressure tool can be used to apply a pressure force to plastic components. A pressure force can be applied by means of a pressure apparatus and/or by means of a robot. The pressure tool can have a working side and a rear side in the direction of extension of the z-axis.

The at least one first component contact section may be arranged on the working side. The at least one first component contact section may extend substantially in a plane spanned by the x-axis and the y-axis or in a plane parallel to the x-axis and the y-axis. The at least one first component contact section may be configured as a planar surface or have a planar surface. The at least one first component contact section may be configured as a single or multiple curved surface or have a single or multiple curved surface. The at least one first component contact section can be designed as a shaped surface or have a shaped surface. The at least one first component contact section may be made of a metal alloy. The at least one first component contact section may be made of a metal alloy with particular invariance of strain with respect to temperature change. The at least one first component contact section may be made of an iron-nickel alloy. The at least one first component contact section may be made of an alloy having a mass fraction of iron about 64% and a mass fraction of about nickel 36%. The at least one first component contact section can be made of an alloy with the material number 1.3912.

The at least one second component contact section may be arranged on the working side. The at least one second component contact section may extend substantially in a plane spanned by the x-axis and the y-axis or in a plane parallel to the x-axis and the y-axis. The at least one second component contact section may have a strand-like, bead-like, gasket-like, profile-like, and/or tubular shape. The at least one second component contact section may be formed by means of a strand-like, bead-like, gasket-like, profile-like, and/or tubular member. The at least one second component contact section may be heat resistant. The at least one second component contact section may be heat resistant up to a temperature above a flow temperature range of a specific thermoplastic. The at least one second component contact section may be heat resistant up to a temperature of about 100° C., up to a temperature of about 150° C., up to a temperature of about 200° C., up to a temperature of about 250° C., and/or up to a temperature of about 300°. The at least one second component contact section may be made of an elastomer. The at least one second component contact section may be made of a silicone rubber or silicone elastomer. The at least one second component contact section may be made of a high temperature crosslinking silicone rubber. The at least one second component contact section may have thermal film insulation.

“Thermally controllable” means in particular that a temperature of the pressure tool, in particular a temperature of the first component contact section, is controllable in terms of control technology and/or regulation technology.

The at least one first component contact section and the at least one second component contact section can be arranged adjacent to each other along a boundary line. The boundary line can run in a plane spanned by the x-axis and the y-axis or in a plane parallel to the x-axis and the y-axis. The boundary line may be straight at least in sections. The boundary line may be single or multiple curved at least in sections. The boundary line can run essentially in the direction in which the longitudinal axis extends.

The pressure tool can have a rim section. The rim section can be arranged on the working side. The rim section may be a rim section in a plane spanned by the x-axis and the y-axis or in a plane parallel to the x-axis and the y-axis. The at least one second component contact section may be arranged on the rim section.

The pressure tool can be structurally integrated with the at least one first component contact section. The pressure tool can be integrally formed with the at least one first component contact section. The pressure tool and the at least one first component contact section can be manufactured together. The pressure tool and the at least one first component contact section can be made of the same material.

The pressure tool may have at least one receiving section set back relative to at least one first component contact section. The at least one receiving section can be set back in the direction of extension of the z-axis. The at least one receiving section may have a groove-like, channel-like and/or step-like shape. The at least one receiving section may extend in the direction of extension of the x-axis. The at least one receiving section may have a groove-like, channel-like, step-like and/or rectangular cross-section in a plane spanned by the y-axis and the z-axis.

The at least one second component contact section can be received at the at least one receiving section. The at least one second component contact section can be firmly connected to the pressure tool at the at least one receiving section in a form-fit, force-fit and/or material-fit manner. The at least one second component contact section can be in an undeformed state with respect to the at least one first component contact section projects. The at least one second component contact section can project in an undeformed state in the direction of extension of the z-axis over the at least one first component contact section. The at least one second component contact section may be deformable into the receiving section under pressure load. The at least one second component contact section may be deformable under pressure load in the direction of extension of the z-axis set back relative to the at least one first component contact section.

The pressure tool can have at least one heating and/or cooling device and/or at least one temperature sensor. The at least one heating and/or cooling device can have at least one electrical heating and/or cooling element. By means of the at least one heating and/or cooling device the pressure tool, in particular the at least one first component contact section, can be temperature controlled. By means of the at least one temperature sensor, a temperature of the pressure tool, in particular of the at least one first component contact section, can be detectable.

The pressure apparatus can be used by means of a robot. The Pressure apparatus can be designed as an effector for a robot. The pressure apparatus may have a first pressure tool and a second pressure tool. The pressure apparatus may include a connection section. The connection section may include at least one mechanical connection, at least one electrical, pneumatic, or hydraulic power connection, and/or at least one electrical signal connection. The pressure apparatus may comprise at least one tool receptacle for a pressure tool. The pressure apparatus may comprise at least one actuator. The at least one actuator may serve to displace the at least one pressure tool relative to a connection section of the pressure apparatus and/or relative to at least one further pressure tool. The at least one actuator may serve to apply a pressure force. The at least one actuator may be a mechanical, electrical, pneumatic, and/or hydraulic actuator. The pressure apparatus may comprise at least one thermal insulation. The at least one thermal insulation may serve to insulate the at least one pressure tool, the actuator and/or from a contact surface.

The pressure apparatus can have a control device. The control device can be used for control and/or regulation controlling. The control device can be an electrical control device. The control device can have a processor, a working memory, a data memory, at least one signal input and/or at least one signal output. The control device can be programmable. By means of the control device the at least one pressure tool, the actuator and/or at least one electrical resistance welding element can be controlled. The control device can be used for controlling a pressure force, in particular a pressure force course. The control device can be used for controlling a temperature, in particular a temperature profile. The control device can be used for monitoring and/or documenting a welding process.

The method can be an electric resistance welding method. The method can be a pressure welding method. The method can be a plastic welding method. The method may be performed for welding longitudinal seams, welding perimeter seams on aircraft, welding longitudinal stiffener structures such as stringer profiles into a skin panel, welding door stiffener structures to a skin panel, and/or welding lap joints and butt joints.

The method comprises the steps of: arranging a first and a second plastic component to be welded together to form a joining section, thereby inserting at least one electrical resistance welding element between common joining contact surfaces of the plastic components; pressing together the plastic components by means of pressure apparatus; plasticizing the plastic components at the joining contact surfaces by means of the at least one resistance welding element to form a welded joint; solidifying the welded joint; removing the pressure apparatus. These steps may be performed in the order indicated. These steps can be carried out at least partially overlapping each other or overlapping each other several times. Between these steps other steps can be performed. Before these steps and/or after these steps other/additional steps can be performed.

The plastic components may comprise a thermoplastic material. The plastic components can have reinforcing fibers. The reinforcing fibers may be embedded in the plastic. The plastic can surround the reinforcing fibers as a matrix material. The reinforcing fibers may be bonded to the matrix material by adhesive interactions. The plastic components may be fiber-plastic composite components. The plastic components can have direction-dependent elasticity behavior. The plastic components may be vehicle components. The vehicle may be a land vehicle, motor vehicle, aircraft, watercraft, or spacecraft. The plastic components may be fuselage components of an aircraft. The plastic components may be wing components of an aircraft. The plastic components may be stiffener components. The plastic components can be stringer profiles. The plastic components can be parts of a skin field.

The plastic components may comprise organic fibers, such as aramid fibers, carbon fibers, polyester fibers, nylon fibers, polyethylene fibers, polymethyl methacrylate fibers and/or inorganic fibers, such as basalt fibers, boron fibers, glass fibers, ceramic fibers, silica fibers. The fibers may be in the form of woven fabric, knitted fabric, braided fabric or stitch-bonded fabric. The fibers may be in the form of a textile. The fibers may be present in a single layer or in multiple layers. The matrix material may comprise polyetheretherketone (PEEK), polyphenylene sulfide (PPS), polysulfone (PSU), polyetherimide (PEI), and/or polytetrafluoroethylene (PTFE).

The plastic components can be electrically conductive or electrically insulating. The plastic components can each have at least one joining contact surface. The at least one joining contact surface can be flat. The at least one joining contact surface can be single-curved or multi-curved. Joining contact surfaces to be welded together or welded plastic components may be referred to as common joining contact surfaces. Common joining contact surfaces can be arranged in single overlap, in single lashing or in butt joint.

By arranging common joining contact surfaces against each other, at least one joining surface and/or at least one joining section can be formed. The at least one joining surface can be flat. The at least one joining surface can be single or multiple curved. The at least one joining surface may extend in a longitudinal direction and in a transverse direction. The at least one joining section may be bounded in a longitudinal direction and in a transverse direction. The at least one joining section may be bounded by a component edge of a plastic component. The longitudinal direction may extend in the direction of extension of an x-axis. The transverse direction may extend in the direction of a y-axis. The plastic components can be joined at their common joining contact surfaces in a joining direction. The joining direction can run in the direction of extension of a z axis. The x-axis, the y-axis and the z-axis can be arranged at right angles to each other.

The at least one resistance welding element can be designed as a resistance heating layer. The at least one resistance welding element can be used to plasticize the plastic components at common joining contact surfaces in order to join the plastic components to one another with a material bond. The at least one resistance welding element may comprise an electrical conductor material. The electrical conductor material may be in the form of a semi-finished product. The electrical conductor material may be fabricatable or fabricated. The electrical conductor material may have a relatively high electrical resistivity and/or a relatively low tendency to oxidize. The electrical conductor material may serve to convert electrical power to heat. The electrical conductor material may be made of a metal and/or carbon. The electrical conductor material may be permeable to plasticized plastic, at least in sections. The electrical conductor material may have openings. The electrical conductor material may be grid-like or fabric-like. The electrical conductor material may be made of wires and/or fibers. The at least one resistance welding element may have at least one electrical contact section. The at least one electrical contact section may be electrically contactable by means of electrodes. The at least one electrical contact section can be arranged outside the joining section.

The at least one resistance welding element may be inserted between common joining contact surfaces of the plastic components via the joining section projecting beyond and/or into at least one joining zone rim section projecting into adjacently to the joining section. The at least one joining zone rim section may be immediately adjacent to the joining section. The at least one joining zone rim section and the joining section may be delimited from each other by a component edge of a plastic component. The at least one joining zone rim section may extend from the joining section into a plastic component. The at least one joining zone rim section may extend along the joining section. The at least one joining zone rim section may extend in a longitudinal direction and in a transverse direction. The longitudinal direction of the at least one joining zone rim section may extend along the joining section. The transverse direction may extend perpendicularly from the joining section into a plastic component. The at least one joining zone rim section may extend in the direction of extension of the x-axis and/or in the direction of extension of the y-axis.

Electrical insulation can be arranged between the at least one resistance welding element and a plastic component. The electrical insulation may have a predetermined minimum heat resistance. The electrical insulation may be heat resistant up to a temperature of about 100° C., up to a temperature of about 150° C., up to a temperature of about 200° C., up to a temperature of about 250° C., and/or up to a temperature of about 300°. The electrical insulation may be a film. The electrical insulation may be self-adhesive. The electrical insulation may be made of polyimide.

For pressing together, the plastic components, the at least one pressure tool can be placed with its first component contact section at the joining section and with its second component contact section at the at least one joining zone rim section. For pressing together, the plastic components, the at least one pressure tool can be placed with its boundary line at least approximately at a boundary between the joining section and the at least one joining zone rim section.

The plastic components can be pressed together after arranging the plastic component and forming the joining section with inserting at least one electrical resistance welding element. The plastic components can be pressed together during plasticizing of the plastic components at the joining contact surfaces and creating of the welded joint. The plastic components can be pressed together during the solidifying of the welded joint. During pressing together, a pressure force, in particular a pressure force course, and/or a temperature, in particular a temperature profile, of the at least one pressure tool can be controlled.

The pressure force, in particular the pressure force course, and/or the temperature, in particular the temperature profile, of the at least one pressure tool and a temperature, in particular a temperature profile, and/or an electrical exposure, in particular an exposure profile, of the at least one resistance welding element can be controlled in a coordinated manner.

During the execution of the method, information about the pressure force, in particular about the pressure force course, and/or about the temperature, in particular about the temperature profile, can be collected, monitored, documented and/or stored.

In summary and in other words, the invention thus provides, among other things, a pressure tool device for electrical resistance welding. A joint connection at application-oriented component scales and geometries can be solved by using the pressure tool device, which has a combination of metal, preferably Invar, a heat-resistant insert, such as silicone and foil insulation, as well as an integrated electrical heater and several thermosensor units, and suitable process control.

The pressure tool device can have the following features: Two-part (above and below a joining zone), metallic pressure tools with semi-finished surface-following, laterally open contact surfaces for the two-dimensional, uniform transmission of pressure forces (welding and cooling pressure) which can be adjusted on the process side and are usually generated pneumatically; To a respective open edge of a welding zone (in the case of single-lap joints typical of laminates at the top on one side and at the bottom on the other side) and with the laterally flush or a few millimeters projecting welding element terminating, flexibly designed pressure zone using a flexible pressure insert (such as heat-resistant silicone) to form a defined edge area, e.g., with cross-sectional dimensions of 3×10 mm (depending on the thickness of the semi-finished product and the width of the tool groove), inserted in the groove provided in the metallic component; two-sided accessibility for the introduction of electrical current into the welding element inserted in the joining zone; insulation of the metallic pressure tool by means of electrically breakdown-proof foil with high heat resistance, preferably self-adhesive polyimide foil; thermal insulation of the pressure tool device from the surroundings (e.g. on the bottom side to the test facility table and on the top side to the pneumatic cylinder); With integrated, controllable and preferably electrical temperature control (e.g. electrical heating cartridges or filaments or induction heating) of the entire pressure tool; Depending on the size of the joining zone and geometry, multiple sensors for temperature monitoring (uniformity of the temperature over the entire contact area and recording of the temperature change during the welding and cooling time) and forwarding to the process monitoring system.

In addition to basic welding process control, the method technology can have the following features: Uniform temperature control of the pressure tool device over the contact surfaces to the constant temperature required on the process side, e.g. 150° C.; Uniformly distributed transmission of the process-side pressure forces to the surface to be welded; Application of a resulting, defined pressure force to the welding element edge area with the flexible insert to form lateral, defined weld seam ends and sufficient heat dissipation in the edge areas during the welding time; High process reliability due to the required, full-surface heat dissipation in all areas of the welding element; Continuous recording of the temperature conditions during the process control.

The welded joint can have the following characteristics: The weld seam is formed after maximum uniformly distributed pressure and temperature action over the joining zone with a microstructure that is as compact as possible and characterized by high crystallinity; the weld seam edge area has a defined and fully bonded weld bead, without sharp-edged or notched surface properties; the increased mechanical load-bearing capacity of the joint resulting from the shape and geometry due to a full-surface bond and a greatly reduced tendency to crack initiation in the edge area.

The invention improves temperature distribution during welding. Local disturbances of the joint, such as air gaps, in particular in an edge area of a joining zone, are avoided. Controlled process control is made possible or improved. An improved connection between plastic components is made possible. Automated, process-reliable, reproducible and/or traceable welding of plastic components is made possible. Efforts, such as labor and/or costs, are reduced.

In the following, embodiments of the invention are described in more detail with reference to figures, thereby showing schematically and by way of example:

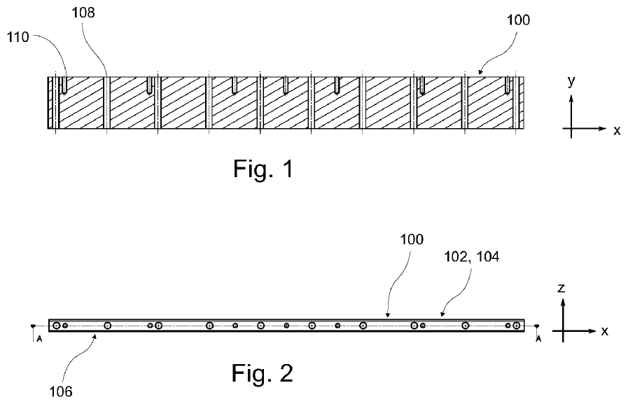

FIG. 1 a pressure tool for applying a pressure force when welding plastic components with a metallic first component contact section in sectional view,

FIG. 2 a pressure tool for applying a pressure force when welding plastic components with a metallic first component contact section in front view,

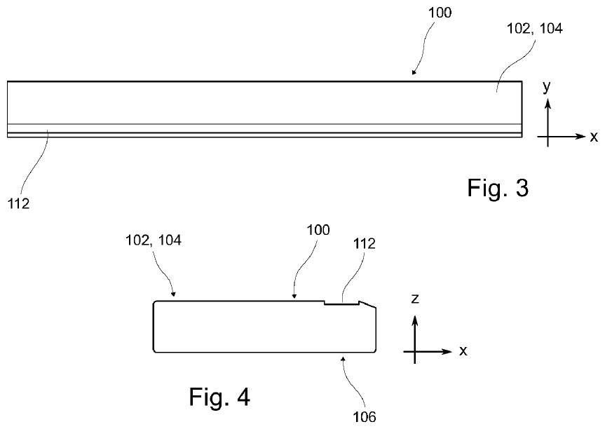

FIG. 3 a pressure tool for applying a pressure force when welding plastic components with a metallic first component contact section in plan view,

FIG. 4 a pressure tool for applying a pressure force when welding plastic components with a metallic first component contact section in side view and

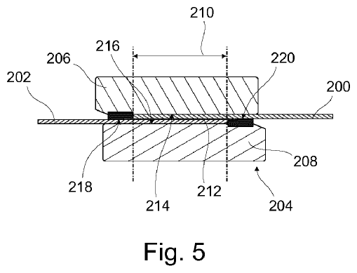

FIG. 5 welding of plastic components by means of a pressure apparatus with two pressure tools.

FIG. 1 shows a pressure tool 100 for applying a pressure force at the welding of plastic components with a metallic first component contact section 102 in sectional view. FIG. 2 shows the pressure tool 100 in front view. FIG. 3 shows the pressure tool 100 in top view. FIG. 4 shows the pressure tool 100 in side view.

The pressure tool is integrally formed with the first component contact section 102 and made of an iron-nickel alloy with a mass fraction of iron of approx. 64% and a mass fraction of approx. nickel of 36%, which exhibits a particular invariance of strain with respect to a temperature change.

The pressure tool 100 has a strip-like shape with a length extending along an x-axis, a width extending along a y-axis, a height extending along a z-axis, a working side 104 and a rear side 106. The first component contact section 102 is arranged on the working side 104 and is configured as a planar surface.

The pressure tool 100 has through holes, such as 108, and blind holes, such as 110, for receiving electrical heating elements and temperature sensors, by means of which the pressure tool 100, in particular the first component contact section 102, is thermally controllable.

The pressure tool 100 has a groove-like receiving section 112 set back from the first component contact section 102 and extending in the direction of the x-axis. The receiving section 112 serves to receive a strand-like elastically deformable element made of a heat-resistant silicone rubber, which forms a second component contact section of the pressure tool 100. The elastically deformable element protrudes from the first component contact section 102 in an undeformed state and is deformable into the receiving section 112 under pressure load.

FIG. 5 shows a welding of plastic components 200, 202 by means of a pressure apparatus 204 with two pressure tools 206, 208. For the pressure tools 206, 208, reference is made in particular to FIG. 1 to FIG. 4 and the associated description. The plastic components 200, 202 are fiber-plastic composite components with carbon fibers embedded in a thermoplastic matrix material and with their common joining contact surfaces arranged in single overlap, forming a joining section 210. An electrical resistance welding element 212 is arranged between the joining contact surfaces of the plastic components 200, 202. The electrical resistance welding element 212 extends beyond the joining section 210 into joining zone rim section.

To weld the plastic components 200, 202, the pressure tools 206, 208 are placed on opposite sides of the joining section 210 with their first component contact section 214, 216 on the joining section 210 and with their second component contact section 218, 220 on the joining zone rim section, and a pressure force is applied so that the plastic components 200, 202 are pressed together between the pressure tools 206, 208 on the joining section 210. Thereby, the elastically deformable elements forming the second component contact sections 218, 220 are deformed into the receiving sections of the pressure tools 206, 208 and each elastically abut a rim of the electrical resistance welding element 212 projecting beyond the joining section 210, a surface of one of the plastic components 200, 202 and a component edge of the other plastic component 202, 200. The resistance welding element 212 is then electrically energized so that the plastic components 200, 202 are plasticized and bonded together at their common joining contact surfaces. After sufficient solidifying of the welded joint, the pressure apparatus 204 is removed. During the pressing together of the plastic components 200, 202, a pressure force course and a temperature profile are controlled.

In particular, “may” refers to optional features of the invention. Accordingly, there are also further embodiments and/or embodiments of the invention which additionally or alternatively have the respective feature or features.

If necessary, isolated features can also be selected from the feature combinations disclosed herein and used in combination with other features to delimit the subject-matter of the claim, while resolving any structural and/or functional relationship that may exist between the features.

### LIST OF REFERENCE SIGNS

100 pressure tool
102 first component contact section
104 working side
106 rear side
108 through hole
110 blind hole
112 receiving section
200 plastic component
202 plastic component
204 pressure apparatus
206 pressure tool
208 pressure tool
210 joining section
212 resistance welding element
214 first component contact section
216 first component contact section
218 second component contact section
220 second component contact section

1. A pressure tool for applying a pressure force during welding of plastic components, the pressure tool comprises at least one metallic first component contact section, wherein the pressure tool has at least one elastically deformable second component contact section and is thermally controllable.

2. The pressure tool of claim 1, wherein the at least one first component contact section and the at least one second component contact section are arranged adjacent to each other along a boundary line.

3. The pressure tool of claim 1, wherein the pressure tool has a rim section and the at least one second component contact section is arranged at the rim section.

4. The pressure tool of claim 1, wherein the pressure tool is formed structurally integrated with the at least one first component contact section, has at least one receiving section set back relative to the at least one first component contact section, and the at least one second component contact section is configured to be received on the at least one receiving section.

5. The pressure tool of claim 4, wherein the at least one second component contact section projects in an undeformed state with respect to the at least one first component contact section and is deformable under pressure load into the receiving section.

6. The pressure tool of claim 1, wherein the pressure tool has at least one heating and/or cooling device and/or at least one temperature sensor.

7. A pressure apparatus for pressing together plastic components during welding, wherein the pressing device has at least one pressure tool for applying a pressure force during welding of plastic components, the pressure tool having at least one metallic first component contact section, wherein the pressure tool has at least one elastically deformable second component contact section and is thermally controllable.

8. The pressure apparatus of claim 7, wherein the pressing device has a control device for controlling a pressure force and/or a temperature.

9. A Method for welding plastic components, wherein the method is carried out by a pressing device having at least one pressure tool for applying a pressure force during welding of plastic components, the pressure tool having at least one metallic first component contact section, wherein the pressure tool has at least one elastically deformable second component contact section and is thermally controllable.

10. The method of claim 9, wherein the following steps are carried out:
arranging a first and a second plastic component to be welded together so that a joining section is formed, thereby inserting at least one electrical resistance welding element between common joining contact surfaces of the plastic components;
pressing the first and second plastic components together by the pressing device;
plasticizing the first and second plastic components at the joining contact surfaces by the at least one resistance welding element in order to produce a welded joint;
solidifying the welded joint; and
removing the pressing device.

11. The method at least one of claim 10, wherein the at least one resistance welding element is inserted between common joining contact surfaces of the plastic components projecting beyond the joining section and/or projecting into at least one joining zone rim section adjacent to the joining section.

12. The method of claim 11, wherein, for pressing the plastic components together, the at least one pressure tool is placed with the first component contact section against the joining section and with the second component contact section against the at least one joining zone rim section.

13. The method of claim 10, wherein during the pressing together a pressure force and/or a temperature of the at least one pressure tool are/is controlled.

14. The method claim 13, wherein the pressure force and/or the temperature of the at least one pressure tool and a temperature and/or an electrical exposure of the at least one resistance welding element are controlled in manner coordinated to each other.

15. (canceled)

16. The pressure apparatus of claim 7, wherein the at least one first component contact section and the at least one second component contact section are arranged adjacent to each other along a boundary line.

17. The pressure apparatus of claim 7, wherein the pressure tool has a rim section and the at least one second component contact section is arranged at the rim section.

18. The pressure apparatus of claim 7, wherein the pressure tool is formed structurally integrated with the at least one first component contact section, has at least one receiving section set back relative to the at least one first component contact section, and the at least one second component contact section is received on the at least one receiving section.

19. The pressure apparatus of claim 18, wherein the at least one second component contact section projects in an undeformed state with respect to the at least one first component contact section and is deformable under pressure load into the receiving section.

20. The pressure apparatus of claim 7, wherein the pressure tool has at least one heating and/or cooling device and/or at least one temperature sensor.
